(19) United States
(12) Patent Application Publication
(10) Pub. No.: US 2010/0278434 A1
(43) Pub. Date: Nov. 4, 2010

(54) FEATURE VECTOR COMPUTATION APPARATUS AND PROGRAM

(76) Inventors: Yusuke UCHIDA, Fujimino-shi (JP); Masaru Sugano, Fujimino-shi (JP); Akio Yoneyama, Fujimino-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/762,696

(22) Filed: Apr. 19, 2010

(30) Foreign Application Priority Data
Apr. 30, 2009 (JP) 2009-111479

(51) Int. Cl. G06K 9/48

(52) U.S. Cl. 382/199

(57) ABSTRACT

A feature vector computation apparatus includes a content obtaining unit that obtains a content; a key frame extractor that detects an instantaneous cut point in the content obtained by the content obtaining unit, and extracts two frames as key frames from the content, based on the instantaneous cut point; a feature vector computation target region extractor that extracts a feature vector computation target region from the two key frame extracted by the key frame extractor; and a feature vector computation unit that computes a feature vector from the feature vector computation target region extracted by the feature vector computation target region extractor.

### BACKGROUND OF THE INVENTION

1. Field of the Invention

The present invention relates to a feature vector computation apparatus and a corresponding program.

Priority is claimed on Japanese Patent Application No. 2009-111479, filed Apr. 30, 2009, the contents of which are incorporated herein by reference.

2. Description of the Related Art

Accompanied with recent spread of broadbands or development of an extended capacity of HDD (hard disk drive), DVD (digital versatile disk), Blu-ray Disc, or the like, digital contents can be easily shared or published via a network, without obtaining permission of owners of copyright or contents providers. Such illegal sharing or publication causes problems. In a recently-proposed technique for solving the problems, “fingerprints” (feature vectors) of digital contents are used to automatically detect a specific content for which the owner of a copyright cannot permit free distribution.

In Patent Document 1, three-dimensional frequency analysis and principal component analysis (PCA) are used for determining a feature vector of each content, thereby detecting a specific content. In the three-dimensional frequency analysis of this method, frequency analysis in a temporal direction (i.e., FFT) is applied to coefficients obtained by spatial frequency analysis (DCT). The coefficients obtained by the three-dimensional frequency analysis are subjected to the principal component analysis, so as to extract feature vectors.

In Patent Document 2, feature vectors used in Patent Document 1 are used for extracting a specific content close to a distributed content. If no content is extracted, a specific content closest to the distributed content is determined by means of phase-only correlation (POC), and it is determined whether both contents are the same, by using a threshold.

In the method disclosed in Non-Patent Document 1, first, an average absolute error between luminances of adjacent frames in video (i.e., motion intensity) is computed, and a frame having an extreme value of the average absolute error is determined to be a key frame. Next, a feature point (or interest point) called “corner” is detected based on each key frame, by using a Harris detector, and extracts a feature vector in the vicinity of the feature point by using a Gaussian derivative. After that, matching between each feature vector and the relevant data base and voting are performed, and the content having a large number of votes is detected to be an illegally distributed content. This method can detect an illegally distributed content even when temporal editing is applied to the relevant video.

### Patent Document 1: Japanese Unexamined Patent Application, First Publication No. 2005-18675.

### Patent Document 2: Japanese Unexamined Patent Application, First Publication No. 2006-285907.

### Patent Document 3: Japanese Unexamined Patent Application, First Publication No. 2007-134986.

### Patent Document 4: Japanese Unexamined Patent Application, First Publication No. 2007-142633.

Non-Patent Document 1: J. Law-To et al., “Video Copy Detection: A Comparative Study”, in Proc. ACM CIVR'07, pp. 371-378, 2007.

### Non-Patent Document 2: Akio Nagasaka and Yuzuru Tanaka, “Automatic Video Indexing and Full-Video Search for Object Appearances”, Proceedings of Information Processing Society of Japan, Vol. 33, No. 4. pp. 543-550, April, 1992

### Non-Patent Document 3: K. Mikolajczyk et al., “A Comparison of Affine Region Detectors”, International Journal of Computer Vision, Vol. 65, No. 1-2, pp. 43-72, 2005.

Non-Patent Document 4: D. G. Lowe, “Distinctive Image Features from Scale-Invariant Keypoints”, International Journal of Computer Vision, Vol. 60, No. 2, pp. 91-110, 2004.

However, in the methods disclosed in Patent-Documents 1 and 2, a feature vector is extracted from a single video content. Therefore, if a temporal editing such as a division of the video content is performed, feature vector detection cannot be executed.

The method disclosed in Non-Patent Document 1 has the following problems. First, in the key frame selection based on the motion intensity, the extreme value for the motion intensity is unstable for noises, which may cause an error in the key frame selection, and degrade the relevant accuracy. In addition, each scene has an individual number of key frames extracted based on the motion intensity. Therefore, redundant key frame extraction may increase the processing time, or an extremely small number of key frames may degrade the detection accuracy. Furthermore, since the detected feature vector based on the Gaussian derivative is relatively sensitive for compression noise or the like, a feature vector to which such a noise is added may degrade the relevant accuracy.

### SUMMARY OF THE INVENTION

In light of the above circumstances, an object of the present invention is to provide a technique to accurately identify a video content which cannot be accurately identified (detected) in conventional techniques and may be a partially extracted video content on a temporal axis or an entirely degraded video content due to compression noise or the like.

Therefore, the present invention provides a feature vector computation apparatus comprising:

a content obtaining unit that obtains a content;

a key frame extractor that detects an instantaneous cut point in the content obtained by the content obtaining unit, and extracts two frames as key frames from the content, based on the instantaneous cut point;

a feature vector computation target region extractor that extracts a feature vector computation target region from the two key frame extracted by the key frame extractor; and

a feature vector computation unit that computes a feature vector from the feature vector computation target region extracted by the feature vector computation target region extractor.

In a typical example, the key frame extractor extracts frames before and after the instantaneous cut point to be the two key frames.

In another typical example, the feature vector computation target region extractor extracts the whole of the two key frames to be the feature vector computation target region.

In another typical example, the feature vector computation target region extractor extracts an individual feature vector computation target region from each of the two key frames.

In a preferable example, the feature vector computation target region extractor extracts:

a feature vector computation target region of one of the two key frames based on a feature region of said one of the two key frames; and

a feature vector computation target region of the other of the two key frames based on the feature region of said one of the two key frames.

In another preferable example, the feature vector computation target region extractor extracts a feature vector computation target region of each of the two key frames based on a feature region of said each of the two key frames, and further extracts a feature vector computation target region of each key frame based on the feature region of the other side of the two key frames.

In another preferable example, the feature vector computation target region extractor extracts:

a feature region of one of the two key frames as the feature vector computation target region thereof; and

a feature vector computation target region of the other of the two key frames, where the extracted region has the same position as that of the feature region of said one of the two key frames.

In another preferable example, the feature vector computation target region extractor extracts a feature region of each of the two key frames as the feature vector computation target region thereof, and further extracts a feature vector computation target region of each key frame, where the extracted region has the same position as that of the feature region of the other side of the two key frames.

In another typical example, the feature vector computation unit determines a principal axis based on a luminance gradient histogram of the feature vector computation target region of one of the two key frames, and computes a feature vector in the feature vector computation target regions of the two key frames based on the principal axis.

In this case, it is possible that:

the feature vector computation unit determines whether or not each feature vector computation target region should be inverted based on a luminance gradient histogram for a direction perpendicular to the principal axis; and

when it is determined that the feature vector computation target region should be inverted, the feature vector computation unit computes the feature vector in the feature vector computation target regions after the inversion.

In another typical example, the feature vector computation unit determines a principal axis based on a luminance gradient histogram of the feature vector computation target region of each of the two key frames, and computes a feature vector in the feature vector computation target region of each of the two key frames based on the corresponding principal axis.

In this case, the feature vector computation unit may compute an angle between the principal axes to be the feature vector.

It is also possible that:

the feature vector computation unit determines whether or not each feature vector computation target region should be inverted based on a luminance gradient histogram for a direction perpendicular to each principal axis; and

when it is determined that the feature vector computation target region should be inverted, the feature vector computation unit computes the feature vector in the feature vector computation target regions after the inversion.

It is also possible that:

the feature vector computation unit determines whether or not each feature vector computation target region should be inverted based on an angle between the principal axes; and

when it is determined that the feature vector computation target region should be inverted, the feature vector computation unit computes the feature vectors in the feature vector computation target regions after the inversion.

The present invention also proposes a program which makes a computer of a feature vector computation apparatus for extracting a feature vector execute:

a content obtaining step that obtains a content;

a key frame extracting step that detects an instantaneous cut point in the content obtained by the content obtaining step, and extracts two frames as key frames from the content, based on the instantaneous cut point;

a feature vector computation target region extracting step that extracts a feature vector computation target region from the two key frame extracted by the key frame extracting step; and

a feature vector computation step that computes a feature vector from the feature vector computation target region extracted by the feature vector computation target region extracting step.

In accordance with the present invention, it is possible to accurately identify a video content which cannot be accurately identified (detected) in conventional techniques and may be a partially extracted video content on a temporal axis or an entirely degraded video content due to compression noise or the like.

### BRIEF DESCRIPTION OF THE DRAWINGS

FIG. 1 is a block diagram showing an example of the structure of a feature vector computation apparatus 1 as an embodiment of the present invention.

FIGS. 2A to 2D are flowcharts showing operation examples, where FIG. 2A shows the operation of the content obtaining unit 10, FIG. 2B shows the operation of the key frame extractor 20, FIG. 2C shows the operation of the feature vector computation target region extractor 30, and FIG. 2D shows the operation of the feature vector computation unit 40.

FIGS. 3A to 3C are diagrams used for explaining the operation of the feature vector computation target region extractor 30 and the feature vector computation unit 40.

### DETAILED DESCRIPTION OF THE INVENTION

Hereinafter, an embodiment of the present invention will be described with reference to the appended figures.

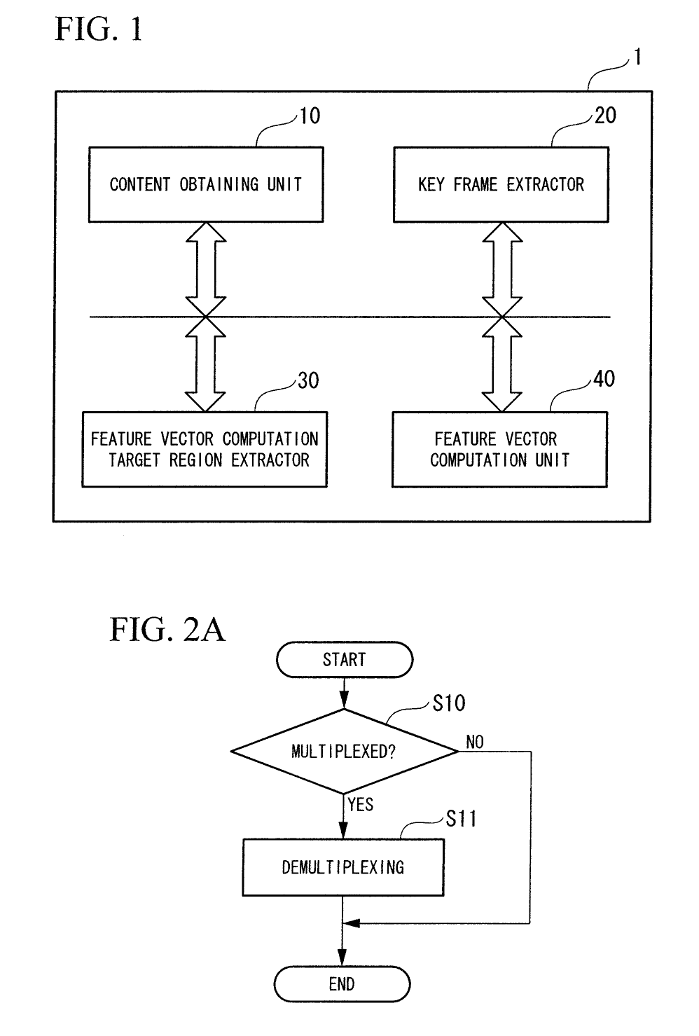

As an embodiment of the present invention, a feature vector computation apparatus 1 extracts a specific feature vector of a content (which may be called a multimedia content, video data, or a video content) so as to use the feature vector for, typically, identifying, recognizing, or searching for the content. As shown in FIG. 1, the feature vector computation apparatus 1 has a content obtaining unit 10, a key frame extractor 20, a feature vector computation target region extractor 30, and a feature vector computation unit 40.

The content obtaining unit 10 obtains (or receives) a content from an external device. When the content obtaining unit 10 obtains a content, the content obtaining unit 10 supplies a video signal of the content to the key frame extractor 20.

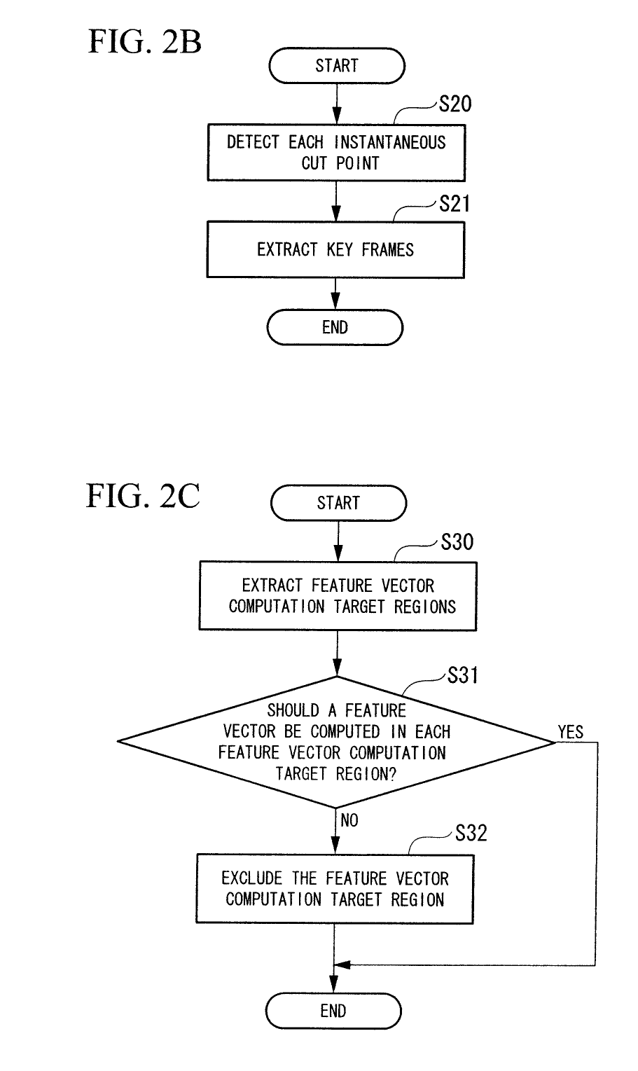

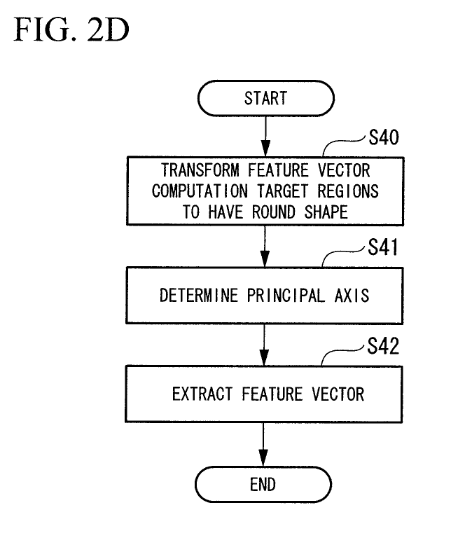

More specifically, as shown in FIG. 2A, the content obtaining unit 10 determines whether or not another signal (e.g., voice or data signal) is multiplexed with the video signal in the obtained content (see step S10). If it is determined that such signal is multiplexed (see “YES” in step S10), the content obtaining unit 10 performs demultiplexing so as to extract only the video signal of the relevant content (see step S11). In contrast, if it is determined that such signal is not multiplexed (see “NO” in step S10), the content obtaining unit 10 omits step S11. The content obtaining unit 10 supplies the relevant video signal to the key frame extractor 20.

The key frame extractor 20 detects each switching point (called an “instantaneous cut point” between two video shots in the content (specifically, video signal thereof) received from the content obtaining unit 10. Based on each instantaneous cut point, the key frame extractor 20 extracts two frames as key frames from the content for the instantaneous cut point. For example, the key frame extractor 20 extracts two adjacent frames positioned immediately before and after each instantaneous cut point (which may be called “adjacent pair frames”) as key frames. The key frame extractor 20 supplies the two key frames (which may be called a “key frame pair”) extracted for each instantaneous cut point to the feature vector computation target region extractor 30.

More specifically, as shown in FIG. 2B, the key frame extractor 20 analyzes the obtained content (video signal), and detects each instantaneous cut point (see step S20). Here, the key frame extractor 20 detects each instantaneous cut point by detecting adjacent frames which have considerably different image features. In other words, the key frame extractor 20 detects each point, at which the corresponding frames which function as adjacent pair frames have considerably different image features, to be an instantaneous cut point. For example, the key frame extractor 20 uses a method as disclosed in Patent-Document 3 or 4 or Non-Patent Document 2. After detecting each instantaneous cut point, the key frame extractor 20 extracts adjacent pair frames assigned to each instantaneous cut point to be a key frame pair (see step S21), and supplies each key frame pair to the feature vector computation target region extractor 30.

Instead of the adjacent pair frames, the key frame extractor 20 may detect two frames, which are distant from each other by a predetermined number of frames, to be a key frame pair. For example, if the adjacent pair frames are an f-th frame and an (f+1)th frame, then an (f-K)th frame and an (f+K+1)th frame (K being an integer which is not negative) may be extracted to form a key frame pair. In addition, the key frame extractor 20 also supplies time information of the f-th frame to the feature vector computation target region extractor 30 regardless of whether or not the adjacent pair frames are extracted.

The feature vector computation target region extractor 30 extracts a target region (called a “feature vector computation target region”) for feature vector computation from the two key frames (i.e., key frame pair) extracted by the key frame extractor 20.

For example, the feature vector computation target region extractor 30 extracts a feature region as an individual feature vector computation target region from each of the two key frames which form a key frame pair.

In another example, the feature vector computation target region extractor 30 extracts the whole of the two key frames to be a feature vector computation target region. That is, the whole of each key frame as a constituent of the relevant key frame pair may be handled as a feature vector computation target region.

In another example, the feature vector computation target region extractor 30 extracts a feature region (as a feature vector computation target region) from one of two key frames which form a key frame pair, and extracts a feature vector computation target region of the other of the two key frames based on the feature region extracted from said one of the key frames.

In another example, the feature vector computation target region extractor 30 extracts respective feature regions (as feature vector computation target regions) from two key frames which form a key frame pair, and further extracts a feature vector computation target region from each of the two key frames based on the feature region extracted from the key frame other than the key frame from which the feature vector computation target region is further extracted.

The feature vector computation target region extractor 30 extracts (i) a feature region (as a feature vector computation target region) from one of two key frames which form a key frame pair, and (ii) a region at an identical position to the feature region to be a feature vector computation target region of the other of the two key frames. Instead of the above process, the feature vector computation target region extractor 30 may use a specific formula for coordinate transformation (e.g., parallel translation) so as to subject the feature region (extracted, as a feature vector computation target region, from said one of the key frames) to coordinate transformation and determine the coordinate-transformed region to be the feature vector computation target region of the other key frame.

The feature vector computation target region extractor 30 supplies each extracted feature vector computation target region to the feature vector computation unit 40 Each feature vector computation target region should have a size of one pixel or greater, that is, a feature vector computation target “point” having a size of one pixel also functions as a feature vector computation target region. The identical condition is assigned to the term “feature region” as a feature vector computation target region.

For each extracted feature vector computation target region, the feature vector computation target region extractor 30 may determine a region (in the extracted region) in which no feature vector computation target region should be computed, so as to supply only a feature vector computation target region in which a feature vector should be computed to the feature vector computation unit 40.

Below, the operation of the feature vector computation target region extractor 30 will be explained in detail, where the operation includes (i) extraction of respective feature regions as feature vector computation target regions from two key frames, (ii) further extraction of a respective feature vector computation target region from each of the two key frames based on the feature region extracted from the other key frame than said each of the two key frames, and (iii) determination of a region (in each extracted feature vector computation target region) in which no feature vector should be extracted.

The feature vector computation target region extractor 30 subjects all key frame pairs (obtained from the key frame extractor 20) to the following processes, where key frames Iₜ⁻ and Iₜ⁺ form a t-th key frame pair.

As shown in FIG. 2C, the feature vector computation target region extractor 30 extracts a plurality of feature regions (as feature vector computation target regions) from each of the key frames Iₜ⁻ and Iₜ⁺ (see step S30). Preferably, each extracted feature region is unchanged for any scaling or rotation, and has robust characteristics for affine transformation. However, such robust characteristics are not required for some objects. The methods disclosed in Non-Patent Documents 3 and 4 can be used for extracting a “robust” region for affine transformation. When no robust characteristics for affine transformation are required, a feature point (or interest point) detecting method such as a Harris operator may be simply used for describing a peripheral region of the relevant point as a circle (or an ellipse) or a square (or an rectangle) which has a fixed size. As described above, a feature point may be extracted as a feature region.

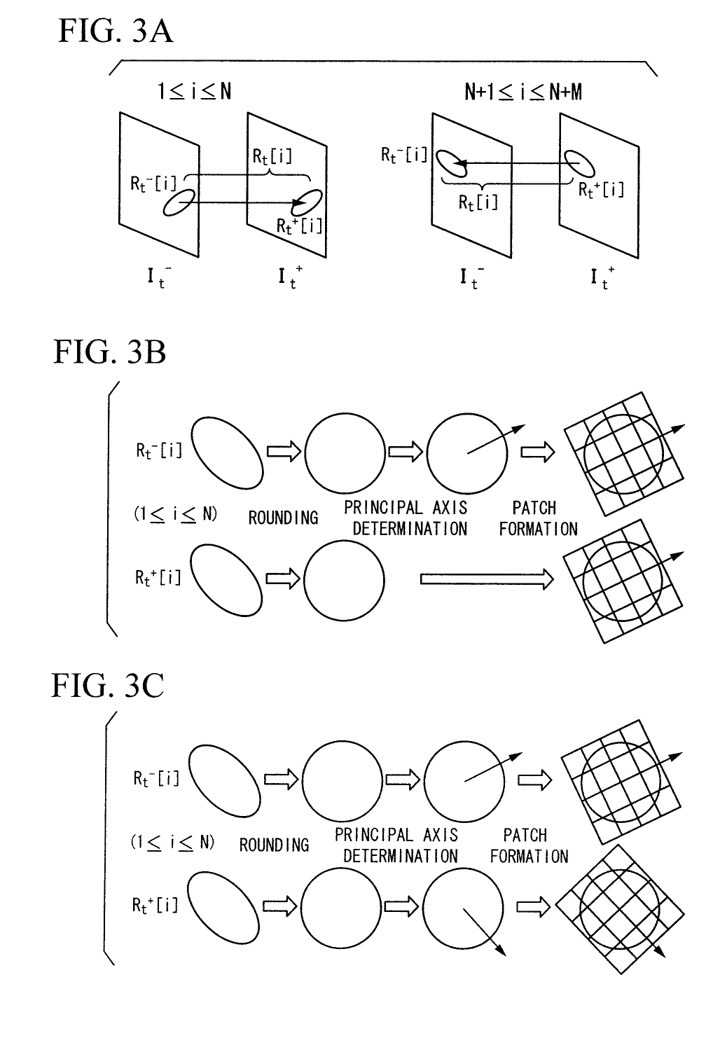

Here it is assumed that N feature regions and M feature regions are respectively extracted from the key frames Iₜ⁻ and Iₜ⁺ by the feature region extraction. When the regions extracted from the key frames Iₜ⁻ are represented by Rₜ⁻[1], Rₜ⁻[2], . . . , Rₜ⁻[N], identical regions Rₜ⁺[i] (in key frame Iₜ⁺) corresponding to Rₜ⁻[i] (1≦i≦N) are extracted, and each pair of the relevant regions is set to be a feature vector computation target region Rₜ[i] for the t-th key frame pair. Similarly, when the regions extracted from the key frames Iₜ⁺ are represented by Rₜ⁺[N+1], Rₜ⁺[N+2], . . . , Rₜ⁺[N+M], identical regions Rₜ⁻[i] (in key frame Iₜ⁻) corresponding to Rₜ⁺[i] (N+1≦i≦N+M) are extracted, and each pair of the relevant regions is set to be a feature vector computation target region Rₜ[i] for the t-th key frame pair. Through the above operation, from the t-th key frame pair, (N+M) feature vector computation target regions Rₜ[i] (1≦i≦N+M) are extracted, as shown in FIG. 3A.

Next, the feature vector computation target region extractor 30 determines whether or not a feature vector should be computed in each feature vector computation target region Rₜ[i] (see step S31). The reason for performing this determination follows. Generally, since the feature vector computation target regions Rₜ⁻[i] (1≦i≦N) and Rₜ⁺[i] (N+1≦i≦N+M) extracted as feature regions each include an edge or blob, a feature vector may be extracted from the relevant feature vector computation target region. In contrast, the feature vector computation target regions Rₜ⁺[i] (1≦i≦N) and Rₜ⁻[i] (N+1≦i≦N+M) have been simply extracted so that they respectively correspond to the feature vector computation target regions Rₜ⁻[i] (1≦i≦N) and Rₜ⁺[i] (N+1≦i≦N+M), and they do not always include an edge or blob. That is, the feature vector computation target regions Rₜ⁺[i] (1≦i≦N) and Rₜ⁻[i] (N+1≦i≦N+M) may each be an entirely flat region having a small luminance variation (variance). Therefore, the feature vector computation target region extractor 30 determines whether or not a feature vector should be computed in each feature vector computation target region by determining whether or not the relevant feature vector computation target region is flat based on the variance of luminance within the feature vector computation target region. If the feature vector computation target region extractor 30 determines that no feature vector should be computed in the relevant feature vector computation target region (see “NO” in step S31), the feature vector computation target region extractor 30 excludes the feature vector computation target region from the objects to be supplied to the feature vector computation unit 40 (see step S32). For example, the feature vector computation target region extractor 30 deletes data of the relevant feature vector computation target region from a temporary storage area for storing all feature vector computation target regions extracted in step S30.

Additionally, the feature vector computation target regions Rₜ⁻[i] and Rₜ⁺[i] may have an identical feature when, for example, the corresponding instantaneous cut point is detected based on a partial change in the relevant frames. In such a case, the corresponding feature vectors have a strong correlation, which reduces a merit obtained by increasing the regions used for computing feature vectors. Therefore, no feature vector may be computed in such regions. For example, the feature vector computation target region extractor 30 computes a mean absolute error (MAE) of the luminance in the feature vector computation target regions Rₜ⁻[i] and Rₜ⁺[i]. If the MAE is smaller than or equal to a predetermined threshold, the feature vector computation target region extractor 30 determines that the feature vector computation target regions Rₜ⁻[i] and Rₜ⁺[i] are similar to each other, and excludes at least one of the feature vector computation target regions from the objects to be supplied to the feature vector computation unit 40.

The feature vector computation unit 40 computes feature vectors from the feature vector computation target regions extracted by the feature vector computation target region extractor 30. More specifically, the feature vector computation unit 40 may determine a principal axis based on a luminance gradient histogram of the feature vector computation target region of one of two key frames, and compute a feature vector in the feature vector computation target regions of the two key frames, based on the principal axis.

In another example, the feature vector computation unit 40 may determine a principal axis based on a luminance gradient histogram of the feature vector computation target region of each of two key frames, and compute respective feature vectors in the feature vector computation target regions of the two key frames, based on the corresponding principal axes. Additionally, the feature vector computation unit 40 may compute the angle between the principal axes to be a feature vector, where only the angle may be computed as a feature vector, or the angle may be computed as one of a plurality of feature vectors.

In another example, the feature vector computation unit 40 determines whether or not each feature vector computation target region should be inverted, based on a luminance gradient histogram for a direction perpendicular to the relevant principal axis. If it is determined that the feature vector computation target region should be inverted, a feature vector is computed in the inverted feature vector computation target regions after the inversion.

In another example, the feature vector computation unit 40 determines whether or not the feature vector computation target regions should be inverted, based on the angle formed by the corresponding principal axes. If it is determined that the feature vector computation target regions should be inverted, feature vectors may be computed in inverted feature vector computation target regions.

In a specific example as shown in FIG. 2D, the feature vector computation unit 40 extracts a feature vector from a feature vector computation target region extracted by the feature vector computation target region extractor 30. The feature vector may be a dominant color, a scalable color, a color structure, a color layout, an edge histogram, or a contour shape, which is published in MPEG-7. In addition, an HOG (histogram of oriented gradient), which Non-Patent Document 4 uses as a robust feature vector with respect to rotation, contrast variation, luminance shift, or the like, may be used as the relevant feature vector.

Below, the feature vector computation process performed by the feature vector computation unit 40 will be further explained with reference to FIG. 3B, which shows an feature vector computation example when using (i) a Harris-Affine detector which Non-Patent Document 4 proposes for the region detection, and (ii) the HOG which Non-Patent Document 4 uses for the feature vector description, where it is defined that 1≦i≦N.

First, the feature vector computation unit 40 transforms the feature vector computation target regions Rₜ⁻[i] and Rₜ⁺[i] to have a round shape (see step S40). As performed in Non-Patent Document 4, the feature vector computation unit 40 determines a principal axis used for describing a feature vector based on a luminance gradient histogram (see step S41). Specifically, the feature vector computation unit 40 determines the principal axis based on one of the feature vector computation target regions Rₜ⁻[i] and Rₜ⁺[i], which is a target feature vector computation target region extracted as a feature region (that is, Rₜ⁻[i] when 1≦i≦N, or Rₜ⁺[i] when N+1≦i≦N+M). Here, the feature vector computation unit 40 may (i) always uses one of the feature vector computation target regions Rₜ⁻[i] and Rₜ⁺[i] to be the relevant target, or (ii) always uses both the feature vector computation target regions Rₜ⁻[i] and Rₜ⁺[i] to be the relevant target.

After determining the principal axis, the feature vector computation unit 40 forms patches consisting of a fixed number (“4×4” in FIG. 3B) of blocks along the principal axis, so that an HOG feature vector is extracted (see step S42).

In another example, if H^{R} and H^{L} respectively represent the total numbers of frequencies in luminance gradient histograms for the directions which satisfy −π<θ<0 and 0<θ<π based on the principal axis, then the feature vector computation target regions Rₜ⁻[i] and Rₜ⁺[i] may be inverted so as to always satisfy the condition H^{R}>H^{L}, and the patches may be formed after the inversion. In this case, feature vector computation target regions which are unchanged for mirror images can be used.

In Non-Patent Document 4, when the patches are formed, an eight-dimensional vector is extracted from each of the 4×4 blocks, so that a totally 128-dimensional feature vector is formed. In the present embodiment, similarly, 128-dimensional feature vectors are extracted from the feature vector computation target regions Rₜ⁻[i] and Rₜ⁺[i], thereby forming a 256-dimensional feature vector. When the dimension of the feature vector increases, the cost for storing and searching for the feature vector may be increased. In such a case, the patches may consist of a 3×3 or smaller number of blocks. In case of “3×3”, a 144-dimensional feature vector is formed. The 144 dimension is almost similar to that of conventional feature vectors, but the size of each block as a patch is relatively large. Therefore, the relevant feature vector has an improved robust characteristic for positional shift, rotation, or other noises.

FIG. 3C shows an example of determining principal axes from both the feature vector computation target regions Rₜ⁻[i] and Rₜ⁺[i]. In this case, the feature vector computation unit 40 forms respective feature vectors in the feature vector computation target regions Rₜ⁻[i] and Rₜ⁺[i].

The feature vector computation unit 40 may determine the angle θ (−π≦θ<π) formed by the principal axis of the feature vector computation target region Rₜ⁻[i] and the principal axis of the feature vector computation target region Rₜ⁺[i] (i.e., angle difference between the principal axes) to be a feature vector.

When subjecting the extracted feature vectors to a matching operation, targets for the matching can be limited to those having close angle differences θ, or classification of a database for storing matching data can be performed based on the angle difference θ, thereby improving the processing speed for identification, recognition, or search of contents.

In another example, the feature vector computation unit 40 inverts the feature vector computation target region Rₜ⁻[i] or Rₜ⁺[i] so that the above angle difference θ always satisfies the condition “0<θ<π”, and computes feature vectors from the feature vector computation target regions after the inversion. In this case, feature vectors which are unchanged (robust) for mirror images can be computed.

As described above, in accordance with the feature vector computation apparatus 1, it is possible to accurately identify or detect a video content which may be a partially extracted video content on a temporal axis or an entirely degraded video content due to compression noise or the like, and thus cannot be accurately identified by conventional techniques.

A program for performing the operation of the feature vector computation apparatus 1 as an embodiment of the present invention may be stored in a computer-readable storage medium, and the stored program may be loaded on and executed by a computer system, so as to implement the above-described processes in the operation of the feature vector computation apparatus 1.

The computer system may include an operating system and hardware resources such as peripheral devices. When the computer system uses a WWW (world wide web) system, the relevant environment for providing or displaying homepages are also included in the computer system.

The computer-readable storage medium is a storage device which may be (i) a portable medium such as a flexible disk, a magneto-optical disk, a writable non-volatile memory (e.g., ROM or flash memory), or a CD-ROM, or (ii) a hard disk installed in the computer system.

The computer-readable storage medium may be a memory which stores the program for a specific time, such as a volatile memory (e.g., a DRAM (dynamic random access memory)) in the computer system which functions as a server or client when the program is transmitted via a network (e.g., the Internet) or through a communication line (e.g., telephone line).

The above program may be transmitted from the computer system (which stores the program in a storage device or the like) via a transmission medium (on transmitted waves through the transmission medium) to another computer system. The transmission medium through which the program is transmitted is a network such as the Internet or a communication line such as a telephone line, that is, a medium which has a function of transmitting data. In addition, a program for performing a portion of the above-explained processes may be used. Furthermore, a differential file (i.e., a differential program) to be combined with a program which has already been stored in the computer system may be provided to realize the above processes.

While preferred embodiments of the present invention have been described and illustrated above, it should be understood that these are exemplary embodiments of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A feature vector computation apparatus comprising:
a content obtaining unit that obtains a content;
a key frame extractor that detects an instantaneous cut point in the content obtained by the content obtaining unit, and extracts two frames as key frames from the content, based on the instantaneous cut point;
a feature vector computation target region extractor that extracts a feature vector computation target region from the two key frame extracted by the key frame extractor; and
a feature vector computation unit that computes a feature vector from the feature vector computation target region extracted by the feature vector computation target region extractor.

2. The feature vector computation apparatus in accordance with claim 1, wherein:
the key frame extractor extracts frames before and after the instantaneous cut point to be the two key frames.

3. The feature vector computation apparatus in accordance with claim 1, wherein:
the feature vector computation target region extractor extracts the whole of the two key frames to be the feature vector computation target region.

4. The feature vector computation apparatus in accordance with claim 1, wherein:
the feature vector computation target region extractor extracts an individual feature vector computation target region from each of the two key frames.

5. The feature vector computation apparatus in accordance with claim 1, wherein the feature vector computation target region extractor extracts:
a feature vector computation target region of one of the two key frames based on a feature region of said one of the two key frames; and
a feature vector computation target region of the other of the two key frames based on the feature region of said one of the two key frames.

6. The feature vector computation apparatus in accordance with claim 1, wherein:
the feature vector computation target region extractor extracts a feature vector computation target region of each of the two key frames based on a feature region of said each of the two key frames, and further extracts a feature vector computation target region of each key frame based on the feature region of the other side of the two key frames.

7. The feature vector computation apparatus in accordance with claim 1, wherein the feature vector computation target region extractor extracts:
a feature region of one of the two key frames as the feature vector computation target region thereof; and
a feature vector computation target region of the other of the two key frames, where the extracted region has the same position as that of the feature region of said one of the two key frames.

8. The feature vector computation apparatus in accordance with claim 1, wherein:
the feature vector computation target region extractor extracts a feature region of each of the two key frames as the feature vector computation target region thereof, and further extracts a feature vector computation target region of each key frame, where the extracted region has the same position as that of the feature region of the other side of the two key frames.

9. The feature vector computation apparatus in accordance with claim 1, wherein:
the feature vector computation unit determines a principal axis based on a luminance gradient histogram of the feature vector computation target region of one of the two key frames, and computes a feature vector in the feature vector computation target regions of the two key frames based on the principal axis.

10. The feature vector computation apparatus in accordance with claim 1, wherein:
the feature vector computation unit determines a principal axis based on a luminance gradient histogram of the feature vector computation target region of each of the two key frames, and computes a feature vector in the feature vector computation target region of each of the two key frames based on the corresponding principal axis.

11. The feature vector computation apparatus in accordance with claim 10, wherein:
the feature vector computation unit computes an angle between the principal axes to be the feature vector.

12. The feature vector computation apparatus in accordance with claim 9, wherein:
the feature vector computation unit determines whether or not each feature vector computation target region should be inverted based on a luminance gradient histogram for a direction perpendicular to the principal axis; and
when it is determined that the feature vector computation target region should be inverted, the feature vector computation unit computes the feature vector in the feature vector computation target regions after the inversion.

13. The feature vector computation apparatus in accordance with claim 10, wherein:
the feature vector computation unit determines whether or not each feature vector computation target region should be inverted based on a luminance gradient histogram for a direction perpendicular to each principal axis; and
when it is determined that the feature vector computation target region should be inverted, the feature vector computation unit computes the feature vector in the feature vector computation target regions after the inversion.

14. The feature vector computation apparatus in accordance with claim 10, wherein:
the feature vector computation unit determines whether or not each feature vector computation target region should be inverted based on an angle between the principal axes; and
when it is determined that the feature vector computation target region should be inverted, the feature vector computation unit computes the feature vectors in the feature vector computation target regions after the inversion.

15. A program which makes a computer of a feature vector computation apparatus for extracting a feature vector execute:
a content obtaining step that obtains a content;
a key frame extracting step that detects an instantaneous cut point in the content obtained by the content obtaining step, and extracts two frames as key frames from the content, based on the instantaneous cut point;
a feature vector computation target region extracting step that extracts a feature vector computation target region from the two key frame extracted by the key frame extracting step; and
a feature vector computation step that computes a feature vector from the feature vector computation target region extracted by the feature vector computation target region extracting step.
